(19) United States
(12) Patent Application Publication
(10) Pub. No.: US 2004/0000251 A1
(43) Pub. Date: Jan. 1, 2004

(54) Vehicle driven above groun by having two north poles pointing to the north pole and two south poles pointing to the south pole

(76) Inventor: Hanna Albert Awad, Ajaltoun (LB)

Correspondence Address: Hanna Albert Awad, 4721 Nathan West, Sterling Heights, MI, 48310, US

(21) Appl. No.: 10/184,936

(22) Filed: Jul. 1, 2002

(51) Int. Cl. B60L 13/04

(52) U.S. Cl. 104/281

(57) ABSTRACT

as described in FIGS. 1 and 2 the vehicle will have four solenoids at its corners creating four poles. the above two of them having two north poles pointing to the north pole at an angle of 45 degrees. and the rear two poles having two south poles pointing to the south pole. The angle with the horizontal will be adjusted according to the location of the vehicle on earth.

The vehicle will be driven by a gas turbine on hydrogen or by a motor running on the field of the earth or by a compressor pushing on a front cover which is attracted to the vehicle.

The brake will be by acting in the opposite direction.

The power of the magnetic fields of the poles will be determined according to the height needed, of the vehicles above ground.

A solenoid making two poles will be at the center in order to align the vehicle north south.

### CIRCUMSTANCES AND DATE OF CONCEPTION

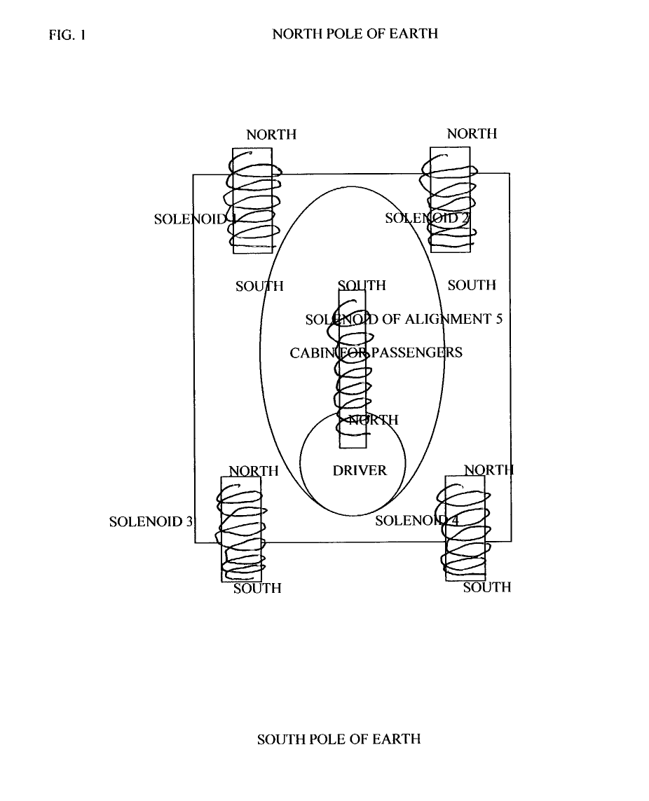

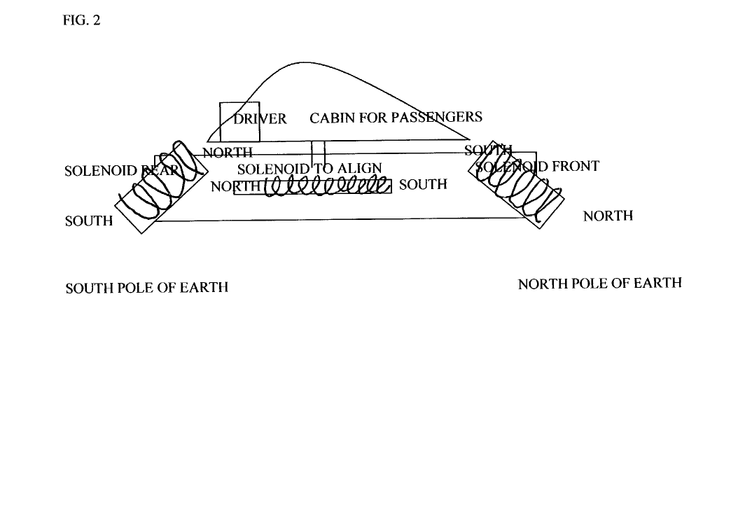

as described in FIGS. 1 and 2 the vehicle will have four solenoids at its corners creating four poles. the above two of them having two north poles pointing to the north pole at an angle of 45 degrees. and the rear two poles having two south poles pointing to the south pole. The angle with the horizontal will be adjusted according to the location of the vehicle on earth.

The vehicle will be driven by a gas turbine on hydrogen or by a motor running on the field of the earth or by a compressor pushing on a front cover which is attracted to the vehicle.

The brake will be by acting in the opposite direction.

The power of the magnetic fields of the poles will be determined according to the height needed, of the vehicle, above ground.

A solenoid making two poles will be at the center in order to align the vehicle north south.

### DESCRIPTION OF THE INVENTION

the invention consist of a vehicle that runs above ground due to the repletion of two north poles created by solenoids by the north pole of the earth, and the repletion of the two rear south poles created by solenoids by the south pole of the earth.

A solenoid will be at the center which will align the vehicle north south by having its south pole attracted by the north pole of the earth and its north pole attracted by the south pole of the earth. the magnitude of its field is just to align and not to move.

The cabin of the passengers above the vehicle will be free to rotate right or left while the base will stable and do not rotate.

PURPOSE: to have a vehicle running above ground

ADVANTAGES: a new era in transportation

Testing Results: a magnet that has its north pole pointing north will be repelled and thrown. So, a high magnitude solenoids will create poles that lift a vehicle above ground.

I claim:

1. the right for the usage of the north and south poles for lifting anything or digging
